(19) United States
(12) Patent Application Publication
(10) Pub. No.: US 2025/0182083 A1
(43) Pub. Date: Jun. 5, 2025

(54) INFORMATION PROCESSING DEVICE AND INFORMATION PROCESSING METHOD

(71) Applicant: KYOCERA Corporation, Kyoto (JP)

(72) Inventor: Xiaoyan DAI, Yokohama-shi, Kanagawa (JP)

(73) Assignee: KYOCERA Corporation, Kyoto (JP)

(21) Appl. No.: 18/842,675

(22) PCT Filed: Mar. 1, 2023
(86) PCT No.: PCT/JP2023/007676

§ 371 Date: Aug. 29, 2024

(30) Foreign Application Priority Data
Mar. 1, 2022 (JP) 2022-031289

(51) Int. Cl. G06Q 20/20; G06V 20/52

(52) U.S. Cl. CPC G06Q 20/208; G06Q 20/201; G06Q 20/202; G06V 20/52

(57) ABSTRACT

An information processing device includes an input unit and a controller. The controller is configured to perform first processing of outputting, to a display device, a recognition result of recognizing what product corresponds to an object contained in a captured image captured by an image-capturing device, perform second processing of storing the recognition result in a storage device and outputting, to the display device, an inquiry as to whether or not there is an unprocessed product when an input accepting the recognition result is received at the input unit, and perform the first processing again when a response that there is an unprocessed product is received at the input unit in response to the inquiry as to whether or not there is an unprocessed product.

### CROSS-REFERENCE TO RELATED APPLICATIONS

This application claims priority from Japanese Patent Application No. 2022-031289 filed in Japan on Mar. 1, 2022, and the entire disclosure of this application is hereby incorporated by reference.

### TECHNICAL FIELD

The present disclosure relates to an information processing device and an information processing method.

### BACKGROUND OF INVENTION

Heretofore, a known technology is configured to recognize what product an object is by capturing an image of the object using an image-capturing device or the like in order to perform payment processing for paying the product price. For example, Patent Literature 1 discloses an article recognition device including an image interface that acquires images of a prescribed location in which multiple articles are disposed.

### CITATION LIST

### Patent Literature

Patent Literature 1: Japanese Unexamined Patent Application Publication No. 2018-129038

### SUMMARY

In an embodiment of the present disclosure, an information processing device includes an input unit and a controller.

The controller is configured to
perform first processing of outputting, to a display device, a recognition result of recognizing what product corresponds to an object contained in a captured image captured by an image-capturing device,
perform second processing of storing the recognition result in a storage device and outputting, to the display device, an inquiry as to whether or not there is an unprocessed product when an input accepting the recognition result is received at the input unit, and
perform the first processing again when a response that there is an unprocessed product is received at the input unit in response to the inquiry as to whether or not there is an unprocessed product.

In an embodiment of the present disclosure, an information processing device includes an input unit and a controller.

The input unit is configured to acquire an input from a user.

The controller is configured to, if the input unit receives an input accepting a recognition result, output to an output unit, of a product contained in a captured image acquired by an image-capturing device, when the input unit receives an input that there is another product to be recognized, cause the output unit to output a recognition result of what product corresponds to an object contained in a newly acquired captured image.

In an embodiment of the present disclosure, an information processing method includes
performing first processing of acquiring data of a captured image, recognizing what product corresponds to an object contained in the captured image, and outputting a recognized recognition result to a user,
performing second processing of, when an input accepting the recognition result is received, storing the recognition result and outputting an inquiry to the user as to whether or not there is an unprocessed product, and
performing the first processing again when a response that there is an unprocessed product is received in response to the inquiry as to whether or not there is an unprocessed product.

### BRIEF DESCRIPTION OF THE DRAWINGS

FIG. 1 is a diagram illustrating an outline configuration of a payment system according to an embodiment of the present disclosure.

FIG. 2 is a diagram illustrating an outline configuration of an information processing system illustrated in FIG. 1.

FIG. 3 is a block diagram of an information processing device illustrated in FIG. 2.

FIG. 4 is a diagram illustrating an image depicting recognition results.

FIG. 5 is a diagram illustrating an image showing an inquiry as to whether or not there are unprocessed products.

FIG. 6 is a diagram illustrating an image showing an explanation of a product placement procedure.

FIG. 7 is a diagram illustrating an image showing total price data.

FIG. 8 is a flowchart illustrating the procedure of an information processing method according to an embodiment of the present disclosure.

FIG. 9 is a flowchart illustrating the procedure of an information processing method according to another embodiment of the present disclosure.

FIG. 10 is a diagram for explaining product density on a placement table.

FIG. 11 is a flowchart illustrating the procedure of an information processing method according to yet another embodiment of the present disclosure.

FIG. 12 is a flowchart illustrating the procedure of an information processing method according to yet another embodiment of the present disclosure.

FIG. 13 is a diagram illustrating an outline configuration of a placement stand and a weight sensor.

FIG. 14 is a flowchart illustrating the procedure of an information processing method according to yet another embodiment of the present disclosure.

FIG. 15 is a flowchart illustrating the procedure of an information processing method according to yet another embodiment of the present disclosure.

### DESCRIPTION OF EMBODIMENTS

There is room for improvement in existing technologies in terms of user convenience. According to an embodiment of the present disclosure, user convenience can be improved.

Embodiments of the present disclosure are described below while referring to the drawings.

### (System Configuration)

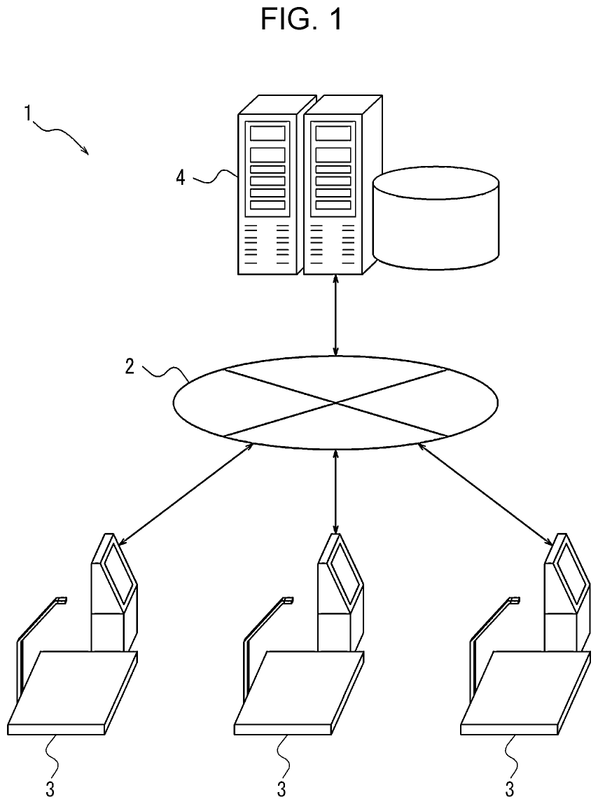

A payment system 1, as illustrated in FIG. 1, is configured as a POS (Point Of Sales) system. The payment system 1 includes at least one information processing system 3 and a server 4. In this embodiment, the payment system 1 includes multiple information processing systems 3.

The information processing systems 3 and the server 4 are able to communicate with each other via a network 2. The network 2 may be any network including the Internet.

The information processing systems 3 may be installed in any store. For example, the information processing systems 3 are installed in a convenience store, a supermarket, or a restaurant.

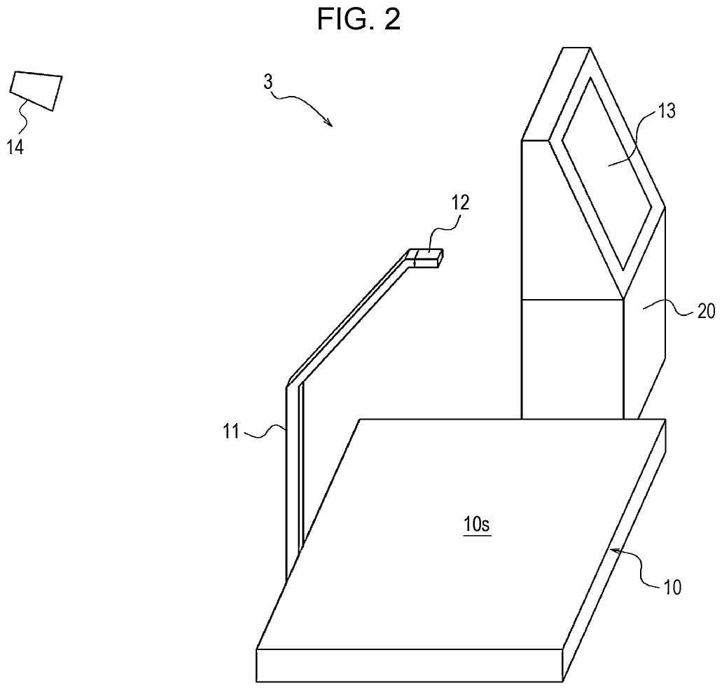

Each information processing system 3 is configured as an unattended cash register. Unattended cash registers are also called self-service cash registers. An unattended cash register is a cash register in which a customer of the store, rather than an employee of the store, performs a series of operations on the cash register. For example, in the information processing system 3, a user, who is a customer of the store, places the products he or she wishes to purchase on a placement table 10 as illustrated in FIG. 2 described below. The information processing system 3 captures an image of the products placed by the user. The information processing system 3 recognizes what products in the store correspond to the objects contained in the captured image generated by image capturing. “Objects contained in the captured image” means objects appearing within the captured image. By recognizing what products in the store correspond to the objects, the information processing system 3 can calculate the total price of the products to be charged to the user, who is a customer of the store. The range in which images of products can be captured by the image-capturing device such as a camera is limited to a certain range. In addition, the range of the table etc. on which products can be placed is limited to a certain range. Therefore, if the user wishes to purchase many products, the user might not be able to capture an image of these products in one go. If the products the user wishes to purchase cannot be captured in one go, the user will need to capture images of the products he or she wishes to purchase in multiple batches. The information processing system 3 can improve user convenience, as described below, even if the user captures images of the products he or she wishes to purchase in multiple batches.

The information processing system 3 is configured as a POS system cash register. The information processing system 3 transmits processing results such as the total price of the products to the server 4 via the network 2.

The server 4 receives the processing results of the information processing system 3 from the information processing system 3 via the network 2. The server 4 manages the inventory status, etc., of the store where the information processing system 3 is installed, based on the received processing results.

As illustrated in FIG. 2, each information processing system 3 includes an image-capturing unit 12 and an information processing device 20. The information processing system 3 further includes the placement table 10, a support column 11, a display device 13, which is an output unit, and an image-capturing device 14. In this embodiment, the information processing device 20 is configured as a separate device from the image-capturing unit 12 and the display device 13. However, the information processing device 20 may be configured so as to be integrated with, for example, at least any one selected from the group consisting of the image-capturing unit 12, the support column 11, the placement table 10, the display device 13, and the image-capturing device 14.

The placement table 10 includes an upper surface 10s. The user places products that he or she wishes to purchase on the upper surface 10s. In this embodiment, the upper surface 10s has a substantially rectangular shape. However, the upper surface 10s may have any shape.

The support column 11 supports the image-capturing unit 12. The support column 11 extends from a side of the placement table 10 to the region above the upper surface 10s. However the way in which the image-capturing unit 12 is supported is not limited to the support column 11. The image-capturing unit 12 may be supported in any way that allows an image of at least part of the upper surface 10s of the placement table 10 to be captured.

The image-capturing unit 12 is capable of generating an image signal corresponding to an image obtained by image capturing. The image-capturing unit 12 is fixed in place so as to able to capture an image of at least part of a surface of the placement table 10, for example, at least part of the upper surface 10s. The image-capturing unit 12 may be fixed in place so that the optical axis thereof is perpendicular to the upper surface 10s. For example, the image-capturing unit 12 is fixed in place so as to be able to capture an image of the entirety of the upper surface 10s of the placement table 10 and so that the optical axis of the image-capturing unit 12 is perpendicular to the upper surface 10s. The image-capturing unit 12 may be fixed to a leading end of the support column 11. The image-capturing unit 12 may continually perform image capturing at any frame rate.

The display device 13, which is an output unit, may be any type of display. The display device 13 displays an image corresponding to an image signal transmitted from the information processing device 20. The display device 13 may function as a touch screen.

The image-capturing device 14 can generate an image signal corresponding to an image generated by image capturing. The image-capturing device 14 is fixed in place so as to be able to capture the scene of the vicinity of the placement table 10. The scene of the vicinity of the placement table 10 includes a user in front of the placement table 10 and users lined up at the information processing system 3 serving as a cash register. The image-capturing device 14 may continually perform image capturing at any frame rate.

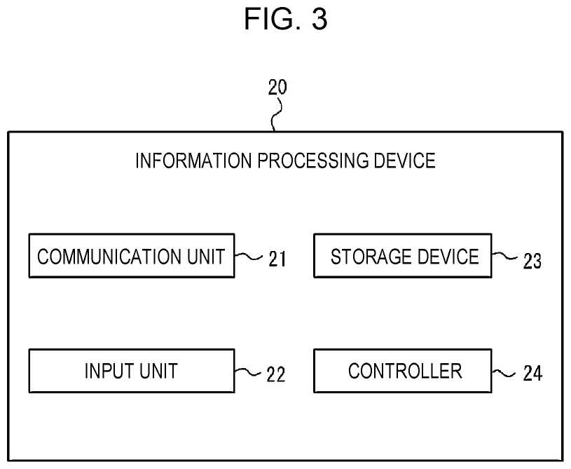

As illustrated in FIG. 3, the information processing device 20 includes a communication unit 21, an input unit 22, a storage device 23, and a controller 24.

The communication unit 21 includes at least one communication module that can connect to the network 2. The communication module is, for example, a communication module that is compatible with standards such as wired LAN (Local Area Network) or wireless LAN. The communication unit 21 is connected to the network 2 via a wired LAN or wireless LAN by the communication module.

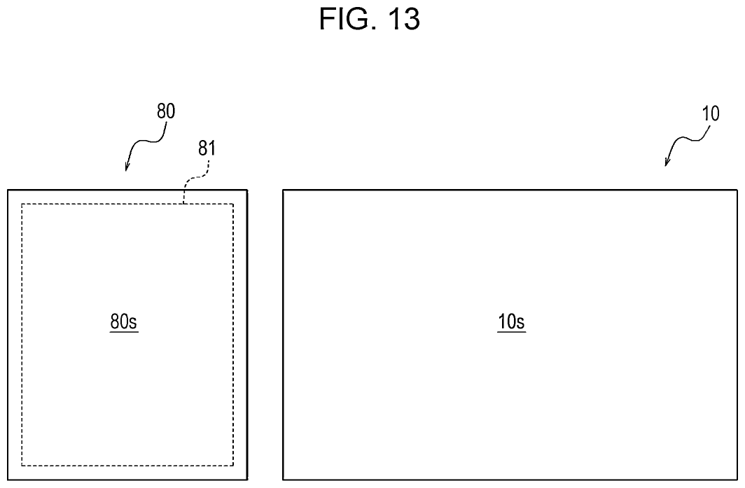

The communication unit 21 includes a communication module capable of communicating with the image-capturing unit 12, the display device 13, and the image-capturing device 14 via communication lines. The communication module is a communication module that is compatible with communication standards of communication lines. The communication lines include at least one out of wired and wireless communication lines. The communication unit 21 may communicate with a weight sensor 81 as illustrated in FIG. 13, which is described later, via the communication module.

The input unit 22 can receive an input from a user. The input unit 22 includes at least one input interface capable of receiving an input from a user. The input interface takes the form of, for example, physical keys, capacitive keys, a pointing device, a touch screen integrated with the display, or a microphone. In this embodiment, the input unit 22 acquires inputs from a touch screen integrated with the display device 13. However, the input unit 22 may be a touch screen integrated with the display device 13.

The storage device 23 includes at least one semiconductor memory, at least one magnetic memory, at least one optical memory, or a combination of at least two of these types of memories. A semiconductor memory is, for example, a RAM (random access memory) or a ROM (read only memory). A RAM is, for example, a SRAM (static random access memory) or a DRAM (dynamic random access memory). A ROM is, for example, an EEPROM (electrically erasable programmable read only memory). The storage device 23 may function as a main storage device, an auxiliary storage device, or a cache memory. The storage device 23 stores data used in operation of the information processing device 20 and data obtained by operation of the information processing device 20.

The controller 24 includes at least one processor, at least one dedicated circuit, or a combination thereof. The processor can be a general-purpose processor such as a CPU (central processing unit) or a GPU (graphics processing unit), or a dedicated processor specialized for particular processing. A dedicated circuit is, for example, a FPGA (field-programmable gate array) or an ASIC (application specific integrated circuit). The controller 24 executes processing relating to operation of the information processing device 20 while controlling the various parts of the information processing device 20.

The controller 24 can accept an input instructing the start of image capturing via the input unit 22. This input can be entered from the input unit 22 by a store clerk, for example, when the store opens. Upon receiving this input, the controller 24 transmits a signal instructing the start of image capturing to the image-capturing unit 12 via the communication unit 21. The controller 24 may transmit a signal instructing the start of image capturing to the image-capturing unit 12 at the time of startup of the information processing device 20, for example.

The controller 24 can accept an input instructing the start of checkout via the input unit 22. This input is input from the input unit 22 by a user who wishes to check out products. After entering this input from the input unit 22, the user places the products that he or she wishes to purchase on the upper surface 10s of the placement table 10. If the user has many products that he or she wishes to purchase and cannot place all the products on the upper surface 10s, the user will first place some of the products he or she wishes to purchase on the upper surface 10s.

### <First Processing>

The controller 24 executes first processing upon receiving an input instructing start of check out. Hereafter, the first processing is described.

The controller 24 acquires data of a captured image. In this embodiment, the controller 24 receives an image signal from the image-capturing unit 12 via the communication unit 21 and thereby acquires data of the captured image corresponding to the image signal. This captured image includes the products that the user has placed on the upper surface 10s of the placement table 10 as objects.

The controller 24 recognizes what products correspond to the objects contained in the acquired captured image. In this embodiment, the controller 24 recognizes what products correspond to the objects by performing object recognition processing on the data of the captured image. Object recognition processing is processing for detecting object images corresponding to objects contained in the captured image and identifying what products correspond to the objects. The controller 24 may perform object recognition processing using a learning model generated by machine learning such as deep learning. However, the controller 24 may perform any processing in order to recognize what products correspond to the objects contained in the captured image. In this embodiment, the controller 24 identifies product names as object recognition. When the controller 24 identifies product names, the controller 24 may identify the numbers of the identified products. In this embodiment, recognition results include the product names and data of the numbers of the recognized products. The object recognition processing does not need to be performed by the controller 24 and may be performed by another server. In this case, the controller 24 may transmit data of the captured image using the communication unit 21 to another server via the network 2. Upon receiving the data of the captured image from the information processing device 20 via the network 2, the other server performs the object recognition processing on the data of the captured image. After performing the object recognition processing, the other server transmits recognition results to the information processing device 20 via the network 2. The controller 24 acquires the recognition results by receiving the recognition results from the other server via the network 2 using the communication unit 21.

The controller 24 outputs the recognition results to the user. In this embodiment, the controller 24 outputs the recognition results to the user by displaying an image representing the recognition results on the display device 13. The controller 24 transmits an image signal corresponding to the image representing the recognition results to the display device 13 via the communication unit 21 and displays the image representing the recognition results on the display device 13.

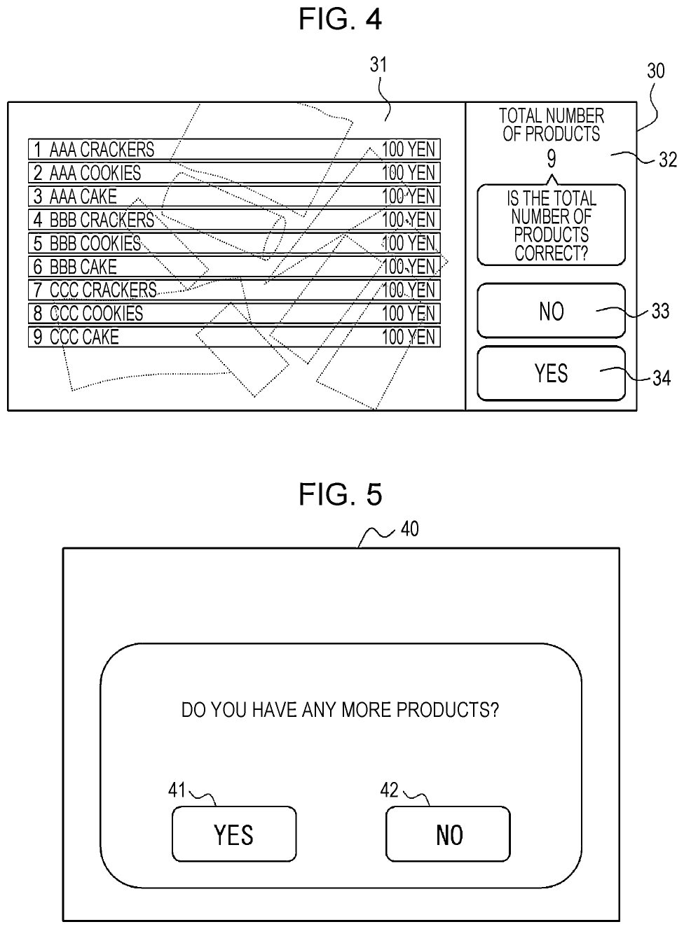

For example, as illustrated in FIG. 4, the controller 24 displays an image 30 on the display device 13. The image 30 includes an image 31 and an image 32. The image 31 is a captured image captured by the image-capturing unit 12. The image 31 includes products placed on the placement table 10 by the user. In the image 31 as illustrated in FIG. 4, the outlines of products are represented by dashed lines. The product names as recognition results are displayed in a superimposed manner on the image 31. As in the image 31, the controller 24 may display price data of the products along with the product names. The price data of the products may be pre-stored in the storage device 23 in association with the product names. The image 32 displays “9” as the number of recognized products as recognition results.

When the image 30, as illustrated in FIG. 4, is displayed on the display device 13, the user checks the recognition results displayed on the display device 13 and determines whether or not the recognition results are correct. When the product names, etc., as the recognition results, are displayed together with the image 31 as illustrated in FIG. 4, the user can easily compare the recognition results with the products placed on the placement table 10. With this configuration, the user can easily check whether or not the recognition results are correct.

When the user determines that the recognition results are incorrect, he or she inputs an input rejecting the recognition results from the input unit 22. For example, the user inputs an input rejecting the recognition results by touching a region 33 as illustrated in FIG. 4. The region 33 is a partial region of the display of the display device 13. “NO” is displayed in the region 33.

When the user determines that the recognition results are correct, the user inputs an input accepting the recognition results from the input unit 22. For example, the user inputs an input accepting the recognition results by touching a region 34 as illustrated in FIG. 4. The region 34 is a partial region of the display of the display device 13. “YES” is displayed in the region 34.

### <Second Processing>

As described above, when the controller 24 outputs the recognition results to the user, the user inputs an input rejecting the recognition results or an input accepting the recognition results from the input unit 22. When the controller 24 outputs the recognition results to the user, the controller 24 performs second processing. Hereafter, the second processing is described.

When the controller 24 receives an input rejecting the recognition results from the input unit 22, the controller 24 modifies the recognition results based on an input from the user received from the input unit 22. The controller 24 displays an image representing the modified recognition results on the display device 13. The user examines the modified recognition results, and if the user determines that the modified recognition results are correct, the user inputs an input from the input unit 22 accepting the recognition results.

When the controller 24 receives an input accepting the recognition results from the input unit 22, the controller 24 stores the recognition results. In this embodiment, the controller 24 stores the recognition results by storing the recognition results in the storage device 23. However, processing for storing the recognition results is not limited to this. As another example, the controller 24 may store the recognition results in the server 4. In this case, the controller 24 transmits the recognition results to the server 4 using the communication unit 21 via the network 2 and stores the recognition results in the server 4.

After storing the recognition results, the controller 24 outputs an inquiry to the user as to whether or not there are unprocessed products. Unprocessed products are, for example, products for which the object recognition processing has not yet been performed, i.e., products that have not been recognized among the products that the same user wishes to purchase. In this embodiment, the controller 24 outputs to the user an inquiry as to whether or not there are unprocessed products by displaying on the display device 13 an image illustrating an inquiry as to whether or not there are unprocessed products. The controller 24 transmits, via the communication unit 21, an image signal corresponding to the image illustrating the inquiry as to whether or not there are unprocessed products to the display device 13, and displays the image illustrating the inquiry as to whether or not there are unprocessed products on the display device 13.

For example, as illustrated in FIG. 5, the controller 24 displays an image 40 on the display device 13. The image 40 displays “DO YOU HAVE ANY MORE PRODUCTS?” as an inquiry as to whether or not there are unprocessed products. Upon viewing the image displayed on the display device 13, the user determines whether or not there are unprocessed products.

If the user determines that he or she has not confirmed the recognition results of all the products he or she wishes to purchase using the image 30 as illustrated in FIG. 4 or determines that there are products that are not placed on the placement table 10, the user determines that there are unprocessed products. For example, if the user has many products he or she wishes to purchase and first placed only some of the products to be purchased on the upper surface 10s, the user determines that there are unprocessed products. When the user determines that there are unprocessed products, he or she inputs a response that there are unprocessed products from the input unit 22. For example, the user enters a response that there are unprocessed products by touching a region 41, as illustrated in FIG. 5. A region 42 is a partial region of the display of the display device 13. “YES” is displayed in the region 41.

If the user determines that he or she has confirmed all the recognition results for the products he or she wishes to purchase using the image 30 illustrated in FIG. 4 or that all the products have already been placed on the placement table 10, the user determines that there are no unprocessed products. If the user determines that there are no unprocessed products, he or she inputs a response that there are no unprocessed products from the input unit 22. For example, the user enters a response that there are no unprocessed products by touching the region 42, as illustrated in FIG. 5. The region 42 is a partial region of the display of the display device 13. “NO” is displayed in the region 42.

Upon receiving a response indicating that there are no unprocessed products from the input unit 22, the controller 24 performs payment processing, which is described later. For example, upon receiving a touch input to the region 42 as illustrated in FIG. 5 from the input unit 22, the controller 24 performs payment processing, which is described later.

Upon receiving a response that there are unprocessed products from the input unit 22, the controller 24 outputs an explanation of a product placement procedure to the user. For example, upon receiving a touch input to the region 41 as illustrated in FIG. 5 from the input unit 22, the controller 24 outputs the explanation of the product placement procedure to the user. The explanation of the product placement procedure may be set as appropriate in accordance with the specifications of the information processing system 3. In this embodiment, the controller 24 outputs the explanation of the product placement procedure to the user by displaying an image illustrating the explanation of the product placement procedure on the display device 13. The controller 24 transmits an image signal corresponding to the image illustrating the explanation of the product placement procedure to the display device 13 via the communication unit 21, and displays the image illustrating the explanation of the product placement procedure on the display device 13.

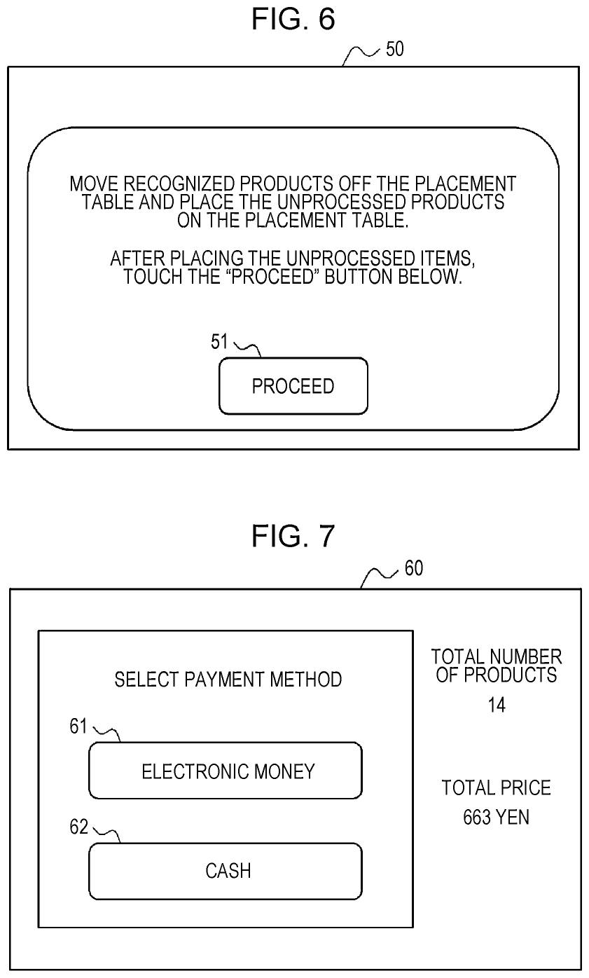

For example, as illustrated in FIG. 6, the controller 24 displays an image 50 on the display device 13. In the image 50, “MOVE THE RECOGNIZED PRODUCTS OFF THE PLACEMENT TABLE AND PLACE THE UNPROCESSED PRODUCTS ON THE PLACEMENT TABLE” is displayed as the explanation of the product placement procedure. The image 50 also displays “AFTER PLACING THE UNPROCESSED PRODUCTS, TOUCH THE “PROCEED” BUTTON BELOW”. When the user sees the image 50, he or she moves the recognized products placed on the upper surface 10s of the placement table 10 off the upper surface 10s. The user places the unprocessed products on the upper surface 10s of the placement table 10 and touches a region 51. The region 51 is a partial region of the display of the display device 13. “PROCEED” is displayed in the region 51. In FIG. 6, the “PROCEED” button is used as an example, but any other button, such as one that allows the user to return to the previous screen, may be disposed using the region 51 or another region.

After outputting the explanation of the product placement procedure to the user, the controller 24 performs the first processing again once the unprocessed products have been placed on the placement table 10. For example, upon receiving a touch input on the region 51 via the input unit 22 as illustrated in FIG. 6, the controller 24 performs the first processing again.

In the first processing performed again, the controller 24 acquires data of a new captured image. This new captured image contains the products that the user has newly placed on the placement table 10 as objects. The controller 24 performs object recognition processing on the data of the new captured image and acquires new recognition results. The new recognition results include the product names of the products newly placed on the placement table 10 by the user, and data of the numbers of the newly recognized products.

In the first processing performed again, the controller 24 may combine the new recognition results with the recognition results acquired in the previous first processing and output the combined results to the user. For example, the controller 24 may combine data of the new product names with the data of the product names acquired in the previous first processing and output the combined data to the user. The controller 24 may also acquire the total number of recognized products by combining the number of newly recognized products with the number of products recognized in the previous first processing. The controller 24 may output the total number of recognized products to the user.

### <Payment Processing>

When the controller 24 receives a response from the input unit 22 that there are no unprocessed products, the controller 24 acquires the stored recognition results. In this embodiment, the controller 24 acquires the recognition results stored in the storage device 23. When the recognition results are stored on the server 4, the controller 24 may acquire the recognition results from the server 4 via the network 2 by receiving the stored recognition results via the communication unit 21. When the controller 24 has performed the first processing multiple times, the controller 24 acquires the stored recognition results for the multiple times.

The controller 24 performs payment processing for paying the product price based on the stored recognition results. For example, the controller 24 calculates the total price of the products by adding up the prices of the recognized products based on the stored recognition results.

The controller 24 outputs data of the total price to the user. The controller 24 may output, to the user, data of the available payment methods and the total number of products together with the total price. In this embodiment, the controller 24 outputs data of the total price to the user by displaying an image illustrating the data of the total price on the display device 13. The controller 24 transmits, via the communication unit 21, an image signal corresponding to the image illustrating the data of the total price to the display device 13, and displays the image on the display device 13.

For example, as illustrated in FIG. 7, the controller 24 displays an image 60 on the display device 13. “633 YEN” is displayed in the image 60 as the total price. “14” is displayed as the total number of products in the image 60. “ELECTRONIC MONEY” is displayed in a region 61 and “CASH” is displayed in a region 62 as the available payment methods in the image 60. When a touch input to the region 61 is accepted at the input unit 22, the controller 24 accepts the selection of electronic money as the payment method. When a touch input to the region 62 is accepted at the input unit 22, the controller 24 accepts the selection of cash as the payment method. The regions 61 and 62 are partial regions of the display of the display device 13. In FIG. 7, “ELECTRONIC MONEY” and “CASH” are used as examples of payment methods, but other payment methods may be employed.

### (System Operation)

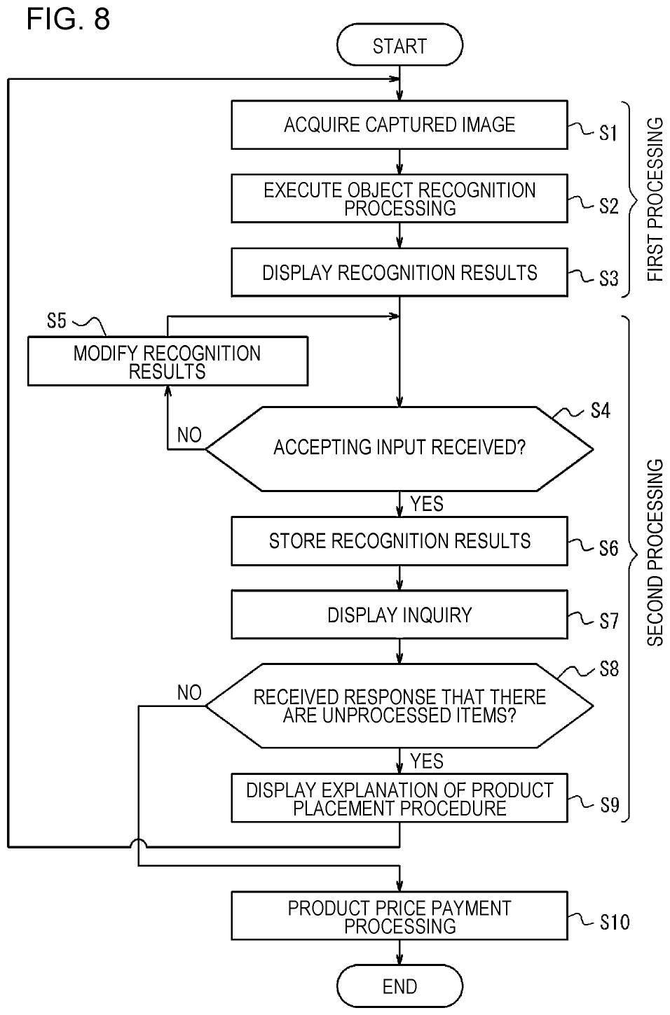

FIG. 8 is a flowchart illustrating the procedure of an information processing method according to an embodiment of the present disclosure. This information processing method includes Steps S1 to S3 as the first processing, Steps S4 to 9 as the second processing, and Step S10 as the payment processing for the product price. For example, upon receiving an input instructing start of checkout from the input unit 22, the controller 24 starts the processing of Step S1.

The controller 24 receives an image signal from the image-capturing unit 12 via the communication unit 21, and thereby acquires data of a captured image corresponding to the image signal (Step S1). The controller 24 performs object recognition processing on the data of the captured image acquired in the processing of Step 1 (Step S2). The controller 24 acquires recognition results by performing the object recognition processing.

The controller 24 displays an image illustrating the recognition results acquired in the processing of Step S2 on the display device 13 (Step S3). For example, the controller 24 displays the image 30 as illustrated in FIG. 4 on the display device 13.

The controller 24 determines whether or not an input accepting the recognition results has been received via the input unit 22 (Step S4).

When the controller 24 determines that an input rejecting the recognition results has been received via the input unit 22 (Step S4: NO), the controller 24 proceeds to the processing of Step S5. For example, when the controller 24 receives a touch input to the region 33 as illustrated in FIG. 4 via the input unit 22, the controller 24 determines that an input rejecting the recognition results has been received via the input unit 22.

When the controller 24 determines that an input accepting the recognition results has been received via the input unit 22 (Step S4: YES), the controller 24 proceeds to the processing of Step S6. For example, when the controller 24 receives a touch input to the region 34 as illustrated in FIG. 4 via the input unit 22, the controller 24 determines that an input accepting the recognition results has been received via the input unit 22.

In the processing of Step S5, the controller 24 modifies the recognition results based on an input from the user received from the input unit 22. After performing the processing of Step S5, the controller 24 returns to the processing of Step S4.

In the processing of Step S6, the controller 24 stores the recognition results by storing the recognition results in the storage device 23.

In the processing of Step S7, the controller 24 displays an image, on the display device 13, illustrating an inquiry as to whether or not there are unprocessed products. For example, the controller 24 displays the image 40 as illustrated in FIG. 5 on the display device 13.

In the processing of Step S8, the controller 24 determines whether or not a response that there are unprocessed products has been received via the input unit 22.

When the controller 24 determines that a response that there are unprocessed products has been received (Step S8: YES), the controller 24 proceeds to the processing of Step S9. For example, when the controller 24 receives a touch input to the region 41 as illustrated in FIG. 5 via the input unit 22, the controller 24 determines that a response that there are unprocessed products has been received.

When the controller 24 determines that a response that there are no unprocessed products has been received (Step S8: NO), the controller 24 proceeds to the processing of Step S10. For example, when the controller 24 receives a touch input to the region 42 as illustrated in FIG. 5 via the input unit 22, the controller 24 determines that a response that there are no unprocessed products has been received.

In the processing of Step S9, the controller 24 displays an image illustrating an explanation of the product placement procedure on the display device 13. For example, the controller 24 displays the image 50 as illustrated in FIG. 6 on the display device 13. After performing the processing of Step S9, the controller 24 returns to the processing of Step S1. For example, after receiving a touch input to the region 51 as illustrated in FIG. 6 via the input unit 22, the controller 24 returns to the processing of Step S1.

In the processing of Step S10, the controller 24 performs payment processing for paying a product price based on the stored recognition results from the processing in Step S6. For example, the controller 24 displays the image 60 as illustrated in FIG. 7 on the display device 13.

When the processing of Steps S1 to S9 is repeated, the controller 24 does not need to perform the processing of Step S9 for the second and subsequent times. So long as the processing of Step S9 is performed once, the user will be able to understand the product placement procedure. If the processing of Step S9 is not performed for the second and subsequent times, when the controller 24 determines that a response that there are unprocessed products has been received (Step S8: YES), the controller 24 returns to the processing of Step S1.

Thus, in the information processing device 20, when the controller 24 receives an input accepting the recognition results via the input unit 22, the controller 24 does not perform the payment processing, but rather outputs to the user an inquiry as to whether or not there are unprocessed products. Furthermore, if the controller 24 receives a response from the input unit 22 that there are unprocessed products in response to the inquiry as to whether or not there are unprocessed products, the first processing is performed again. With this configuration, for example, if the user has many products he or she wishes to purchase and the user is required to capture images of the products he or she wishes to purchase in multiple batches, the payment processing can be performed after the first processing has been performed multiple times. In other words, instead of executing the payment processing each time products the user wishes to purchase are image-captured, payment processing can be executed once all the products the user wishes to purchase have been image-captured in multiple batches. From the user's perspective, the payment processing for the product price only needs to be performed once. Therefore, according to this embodiment, user convenience can be improved.

Furthermore, in the information processing device 20, the controller 24 may output the explanation of the product placement procedure to the user if a response that there are unprocessed products is received via the input unit 22. For example, the controller 24 may display the image 50 as illustrated in FIG. 6 on the display device 13. After outputting the explanation of the product placement procedure to the user, the controller 24 may perform the first processing again. This configuration allows the user to understand how to handle the products and smoothly place the unprocessed products on the upper surface 10s of the placement table 10.

### Another Embodiment

In another embodiment, in the information processing device 20, the controller 24 estimates whether or not the user is unfamiliar with the operation. The controller 24 may estimate whether or not the user is unfamiliar with the operation of the information processing system 3 configured as an unattended cash register.

The controller 24 may estimate whether or not the user is unfamiliar with the operation using any method.

As an example, the controller 24 may measure the time between outputting recognition results to the user in the first processing and receiving an input accepting or rejecting the recognition results via the input unit 22 in the second processing. For example, the controller 24 measures the time from displaying the image 30 illustrated in FIG. 4 on the display device 13 to receiving a touch input to the region 33 or the region 34 via the input unit 22. The controller 24 estimates that the user is unfamiliar with the operation when the measured time is longer than a first time threshold. The first time threshold may be set by estimating the time taken by a typical user to view the recognition results of the image 30 or the like and then to input an input to accept or reject the checked results from the input unit 22.

As another example, the controller 24 may measure the time between detecting the presence of a user in front of the placement table 10 and determining that the user has placed a product on the placement table 10. For example, the controller 24 receives an image signal from the image-capturing device 14 via the communication unit 21. The controller 24 detects the presence of the user in front of the placement table 10 by analyzing data of the captured image corresponding to the received image signal. The controller 24 determines whether the user has placed a product on the placement table 10 by analyzing the data of the captured image corresponding to the received image signal. The controller 24 may estimate that the user is unfamiliar with the operation when the measured time is longer than a second time threshold. The second time threshold may be set based on the time taken by a typical user to stand in front of the placement table 10 and then place a product on the placement table 10.

When the controller 24 estimates that the user is not unfamiliar with the operation and the controller 24 receives a response, via the input unit 22, that there are unprocessed products in response to an inquiry as to whether or not there are unprocessed products in the second processing, the controller 24 does not need to output the explanation of the product placement procedure to the user. The controller 24 may perform the first processing again without outputting the explanation of the product placement procedure to the user. If the user is estimated to be not unfamiliar with the operation, the user is likely to be familiar with the cash register. If the user is familiar with using the cash register, outputting the explanation of the product placement procedure may cause the user to feel annoyed. By not outputting the explanation of the product placement procedure to the user when the user is estimated to be not unfamiliar with the operation, the possibility of the user feeling annoyed is reduced.

When the controller 24 estimates that the user is unfamiliar with the operation and receives a response via the input unit 22 that there are unprocessed products in response to an inquiry as to whether or not there are unprocessed products in the second processing, the controller 24 may output the explanation of the product placement procedure to the user. After outputting the explanation of the product placement procedure to the user, the controller 24 may perform the first processing again once a product is disposed on the placement table 10. When the user is estimated to be unfamiliar with the operation, the user is likely to not know how to place the products. By outputting an explanation of the product placement procedure to the user when the user is estimated to be unfamiliar with the operation, the user will be able to understand out how to handle the products.

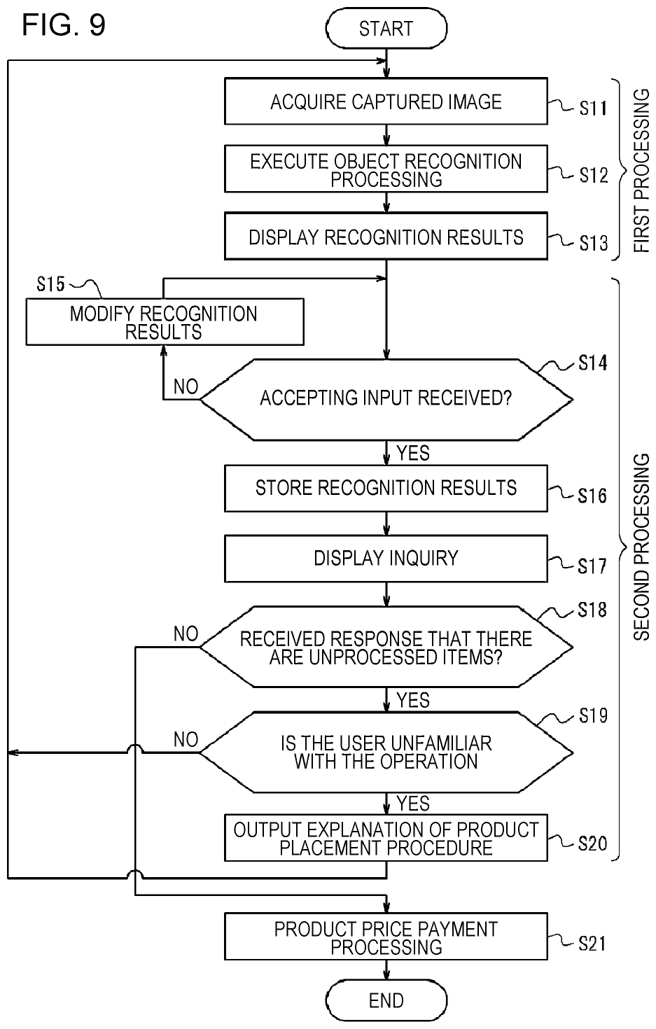

FIG. 9 is a flowchart illustrating the procedure of an information processing method according to another embodiment of the present disclosure. This information processing method includes Steps S11 to S13 as the first processing, Steps S14 to S20 as the second processing, and Step S21 as the payment processing for the product price. However Step S19 may be included in the first processing. For example, upon receiving an input instructing start of checkout via the input unit 22, the controller 24 starts the processing of Step S11.

The controller 24 performs the processing of Steps S11 to S17, which is the same as or similar to the processing of Steps S1 to S7 as illustrated in FIG. 8.

The controller 24 determines whether or not a response that there are unprocessed products has been received at the input unit 22 (Step S18), the same as or similar to the processing of Step S8 as illustrated in FIG. 8. When the controller 24 determines that a response that there are unprocessed products has been received (Step S18: YES), the controller 24 proceeds to the processing of Step S19. When the controller 24 determines that a response that there are no unprocessed products has been received (Step S18: NO), the controller 24 proceeds to the processing of Step S21.

In the processing of Step S19, the controller 24 estimates whether or not the user is unfamiliar with the operation. When the controller 24 estimates that the user is unfamiliar with the operation (Step S19: YES), the controller 24 proceeds to the processing of Step S20. When the controller 24 estimates that the user is not unfamiliar with the operation (Step S19: NO), the controller 24 returns to the processing of Step S11.

The controller 24 performs the processing of Step S20, which is the same as or similar to the processing of Step S9 as illustrated in FIG. 8. The controller 24 performs the processing of Step S21, which is the same as or similar to the processing of Step S10 as illustrated in FIG. 8.

When the processing of Steps S11 to S20 is repeated, the controller 24 does not need to perform the processing of Steps S19 and S20 for the second and subsequent times. If the processing of Steps S19 and S20 is not performed for the second and subsequent times, when the controller 24 determines that a response that there are unprocessed products has been received (Step S18: YES), the controller 24 returns to the processing of Step S11.

Other configurations and effects of the information processing device 20 according to the other embodiment are the same or similar to those of the information processing device 20 according to the embodiment described above.

### Yet Another Embodiment

In yet another embodiment, in the information processing device 20, the controller 24 estimates whether or not there are unprocessed products in the second processing. When the controller 24 estimates that there are no unprocessed products, the controller 24 performs the payment processing for the product price without outputting an inquiry as to whether or not there are any unprocessed products to the user. For example, when the controller 24 estimates that there are no unprocessed products, the controller 24 performs the payment processing without displaying the image 40, as illustrated in FIG. 5, on the display device 13. By executing payment processing without outputting to the user the inquiry as in the image 40 when there are estimated to be no unprocessed products, the burden on the user of checking an image, etc., can be reduced.

The controller 24 may estimate whether or not there are unprocessed products using any method.

As an example, the controller 24 may receive an image signal from the image-capturing device 14 via the communication unit 21 in the second image processing and thereby acquire data of a captured image corresponding to the image signal. This captured image was generated by capturing the scene of the vicinity of the placement table 10. The controller 24 may estimate whether or not there are unprocessed products by analyzing the data of the acquired captured image and identifying whether or not the user in front of the placement table 10 is holding a product. The controller 24 estimates that there are unprocessed products when the user in front of the placement table 10 is identified as holding a product. The controller 24 estimates that there are no unprocessed products when the user in front of the placement table 10 is identified as not holding a product.

As another example, the controller 24 may estimate whether or not there are unprocessed products by analyzing the data of the captured image acquired from the image-capturing unit 12. As described above, this captured image contains products that the user has placed on the placement table 10 as objects. When the user has many products he or she wishes to purchase and needs to capture images of the products in multiple batches, the user may attempt to place as many of the products as possible on the placement table 10 at one time in order to reduce the time and effort involved in placing the products multiple times. Accordingly, the controller 24 may analyze data of the acquired captured image and when the number of products placed on the placement table 10 exceeds a quantity threshold, the controller 24 may estimate that there are unprocessed products. The controller 24 may estimate that there are no unprocessed products when the number of products placed on the placement table 10 is less than or equal to the quantity threshold. The quantity threshold may be set based on an average number of products placed on the placement table 10 etc. The controller 24 may acquire data of the number of products placed on the placement table 10 from the results of the object recognition processing in the first processing.

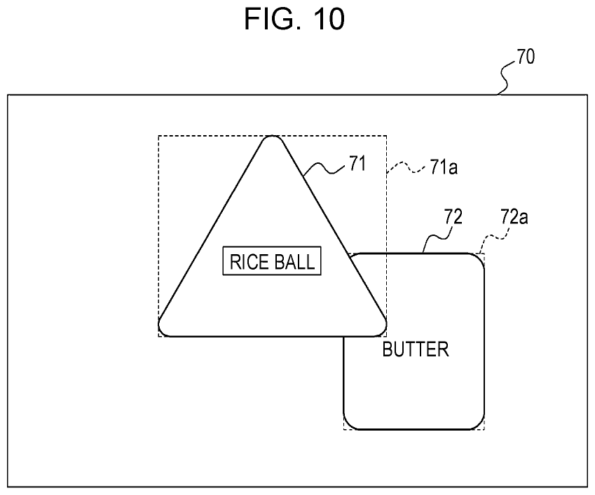

As yet another example, the controller 24 may acquire the placement density of products on the placement table 10 by analyzing data of a captured image acquired from the image-capturing unit 12. As described above, when a user needs to capture images of the products in multiple batches, he or she may try to place as many of the products as possible on the placement table 10. Therefore, the user will try to place the products on the placement table 10 in a crowded manner. Consequently, when the acquired placement density of the products exceeds a density threshold, the controller 24 may estimate that there are unprocessed products. When the acquired placement density of the products is less than or equal to the density threshold, the controller 24 may estimate that there are no unprocessed products. The density threshold may be set based on the average placement density etc. of the products on the placement table 10. The controller 24 may acquire the placement density of products on the placement table 10 based on the degrees of overlap between bounding rectangles of different object images contained in the captured image. The greater the degree of overlap between the bounding rectangles of the different object images, the greater the placement density of products on the placement table 10 may be. The controller 24 may acquire the placement density of products on the placement table 10 by using information on bounding rectangles used to detect object images from the captured image in the object recognition processing in the first processing. For example, a captured image 70, as illustrated in FIG. 10, was captured by the image-capturing unit 12. The captured image 70 includes an object image 71 and an object image 72. The object image 71 is an object image of a rice ball. The object image 72 is an object image of butter. The object image 71 is bounded by a bounding rectangle 71a. The object image 72 is bounded by a bounding rectangle 72a. The controller 24 acquires the placement density of products on the placement table 10 based on the degree of overlap between the bounding rectangle 71a and the bounding rectangle 72a.

As yet another example, the controller 24 may estimate whether or not there are unprocessed products by using a learning model generated by machine learning such as deep learning. This learning model may be generated by machine learning to output an estimation result and reliability of whether or not there are unprocessed products when input with data of captured images acquired from the image-capturing unit 12. The reliability is an indicator indicating the certainty of the estimation result. The learning model may be generated by machine learning to estimate whether or not there are unprocessed products based on at least either one of the number of products placed on the placement table 10 and the placement density of products on the placement table 10.

As described below, the controller 24 may perform processing in accordance with the reliability when estimating whether or not there are unprocessed products using the learning model.

When the controller 24 estimates that there are no unprocessed products using the learning model and the reliability exceeds a reliability threshold, the controller 24 may perform the payment processing without outputting an inquiry to the user as to whether or not there are any unprocessed products. The reliability threshold may be set based on, for example, the percentage of correct past estimation results. When the reliability exceeds the reliability threshold, the reliability of an estimation result that there are no unprocessed products is more reliable. With this configuration, the burden on the user to check images, etc., can be reduced.

When the controller 24 estimates that there are unprocessed products using the learning model and the reliability exceeds the reliability threshold, the controller 24 may perform the first processing again without outputting to the user an inquiry as to whether or not there are unprocessed products. When the reliability exceeds the reliability threshold, the reliability of an estimation result that there are unprocessed products is more reliable. With this configuration, the burden on the user to check images, etc., can be reduced.

When the reliability is less than or equal to the reliability threshold, the controller 24 may output an inquiry to the user as to whether or not there are unprocessed products, regardless of the estimation result as to whether or not there are unprocessed products. When the reliability is less than or equal to the reliability threshold, an estimation result as to whether or not there are unprocessed products is less reliable. With this configuration, the possibility of the estimation results of the learning model being wrong and disadvantageous to the user is reduced.

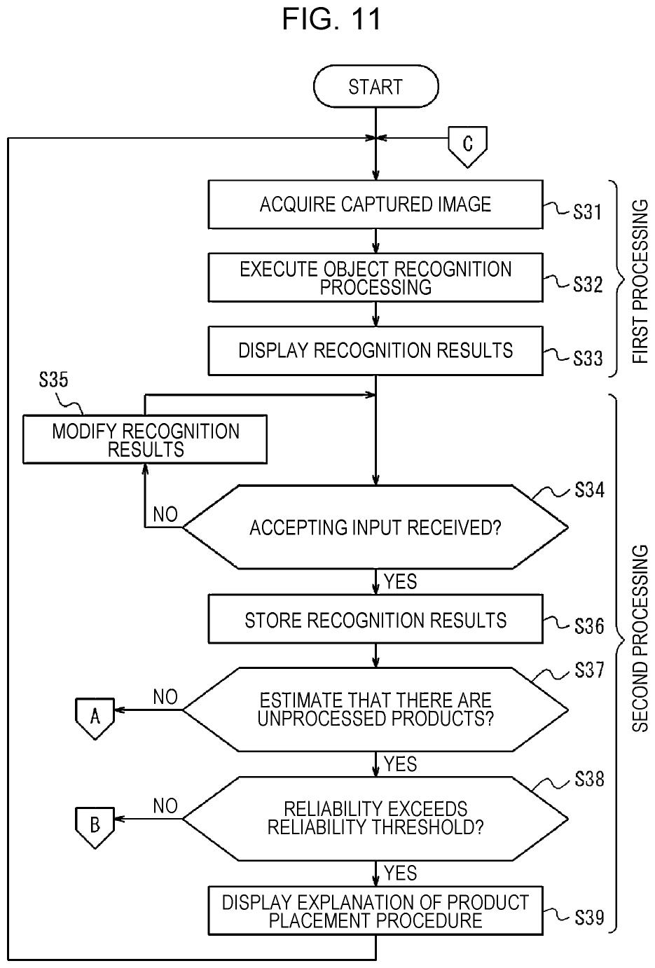

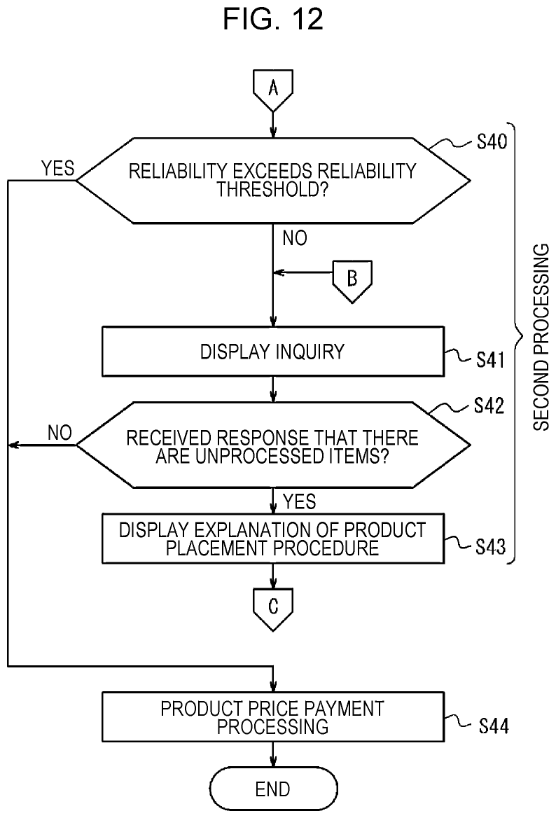

FIGS. 11 and 12 are flowcharts illustrating the procedures of an information processing method according to yet another embodiment of the present disclosure. This information processing method includes Steps S31 to S33 as the first processing, Steps S34 to S43 as the second processing, and Step S44 as the payment processing for the product payment amount. For example, upon receiving an input instructing start of checkout from the input unit 22, the controller 24 starts the processing of Step S31. Hereafter, the controller 24 is assumed to estimate whether or not there are unprocessed products using the learning model.

The controller 24 performs the processing of Steps S31 to S36, which is the same as or similar to the processing of Steps S1 to S6 as illustrated in FIG. 8.

In the processing of Step S37, the controller 24 estimates whether or not there are unprocessed products using the learning model. In the processing of Step S37, the controller 24 acquires the reliability of the estimation result of whether or not there are unprocessed products from the learning model. When the controller 24 estimates that there are unprocessed products (Step S37: YES), the controller 24 proceeds to the processing of Step S38. When the controller 24 estimates that there are no unprocessed products (Step S37: NO), the controller 24 proceeds to the processing of Step S40 as illustrated in FIG. 12.

In the processing of Step S38, the controller 24 determines whether or not the reliability acquired in the processing of Step S37 exceeds the reliability threshold. When the reliability is determined to exceed the reliability threshold (Step S38: YES), the controller 24 proceeds to the processing of Step S39. When the reliability is determined to be less than or equal to the reliability threshold (Step S38: NO), the controller 24 proceeds to the processing of Step S41 as illustrated in FIG. 12.

The controller 24 performs the processing of Step S39, which is the same as or similar to the processing of Step S9 as illustrated in FIG. 8. After performing the processing of Step S39, the controller 24 returns to the processing of Step S31.

In the processing of Step S40 as illustrated in FIG. 12, the controller 24 determines whether or not the reliability acquired in the processing of Step S37 exceeds the reliability threshold. When the reliability is determined to exceed the reliability threshold (Step S40: YES), the controller 24 proceeds to the processing of Step S44. When the reliability is determined to be less than or equal to the reliability threshold (Step S40: NO), the controller 24 proceeds to the processing of Step S41.

The controller 24 performs the processing of Steps S41 to S44, which is the same as or similar to the processing of Steps S7, S8, S9, and S10 as illustrated in FIG. 8. After performing the processing of Step S43, the controller 24 returns to the processing of Step S31 as illustrated in FIG. 11.

In the processing of Step S37, the controller 24 does not need to acquire the reliability. When the reliability is not acquired, in the processing of Step S37, the controller 24 may estimate whether or not there are unprocessed products using a method other than a learning model. When the reliability is not acquired, the controller 24 does not need to performed the processing of Steps S38 and S40 to S43. If the processing of Step S38 etc. is not performed, when the controller 24 estimates that there are unprocessed products (Step S37: YES), the controller 24 proceeds to the processing of Step S39. When the controller 24 estimates that there are no unprocessed products (Step S37: NO), the controller 24 proceeds to the processing of Step S44.

When the processing of Steps S31 to S43 is repeated, the controller 24 does not need to perform the processing of Steps S39 and S43 for the second and subsequent times. If the processing of Step S39 is not performed for the second and subsequent times, when the controller 24 determines that the reliability exceeds the reliability threshold (Step S38: YES), the controller 24 returns to the processing of Step S31. If the processing of Step S43 is not performed for the second and subsequent times, when the controller 24 determines that a response that there are unprocessed products has been received (Step S42: YES), the controller 24 returns to the processing of Step S31.

Other configurations and effects of the information processing device 20 according to the yet another embodiment are the same or similar to those of the information processing device 20 according to the embodiment described above.

### Yet Another Embodiment

In yet another embodiment, in the information processing device 20, the controller 24 estimates whether or not there are unprocessed products based on the weight of the shopping basket in the second processing. The weight of the shopping basket is the sum of the weight of the shopping basket itself and the weight of the products etc. in the shopping basket.

The controller 24 may acquires data on the weight of the shopping basket using any method.

As an example, as illustrated in FIG. 13, a placement stand 80 is provided in the vicinity of the placement table 10. The placement stand 80 is a stand on which the user may place his or her shopping basket. The placement stand 80 includes an upper surface 80s and the weight sensor 81. The user places the shopping basket on the upper surface 80s and places the products in the shopping basket on the placement table 10. The weight of the shopping basket is applied to the upper surface 80s. The weight sensor 81 can measure the weight applied to the upper surface 80s. The controller 24 acquires weight data of the shopping basket from the weight sensor 81 by receiving the weight data measured by the weight sensor via the communication unit 21.

When the weight of the shopping basket is less than or equal to a first weight threshold, the controller 24 may estimate that there are no unprocessed products. The first weight threshold may be set based on the weight of the shopping basket itself and so on. When the controller 24 estimates that there are no unprocessed products, the controller 24 may perform the payment processing without outputting an inquiry to the user as to whether or not there are unprocessed products. By executing payment processing without outputting to the user the inquiry as in the image 40 when there are estimated to be no unprocessed products, the burden on the user of checking an image, etc., can be reduced.

When the weight of the shopping basket exceeds a second weight threshold, the controller 24 may estimate that there are unprocessed products. The second weight threshold may be set based on a measurement error of the weight sensor 81 and so forth. The second weight threshold is larger than the first weight threshold. When the controller 24 estimates that there are unprocessed products, the first processing may be performed again without outputting an inquiry to the user as to whether or not there are unprocessed products. By performing the first processing again without outputting an inquiry to the user as in the image 40 when there have estimated to be unprocessed products, the burden on the user of checking an image, etc., can be reduced.

When the weight of the shopping basket exceeds the first weight threshold and is less than or equal to the second weight threshold, the controller 24 may output an inquiry to the user as to whether or not there are unprocessed products. When the weight of the shopping basket exceeds the first weight threshold and is less than or equal to the second weight threshold, the estimation result as to whether or not there are unprocessed products is less reliable. With this configuration, the possibility of the estimation result of whether or not there are unprocessed products being wrong and disadvantageous to the user is reduced.

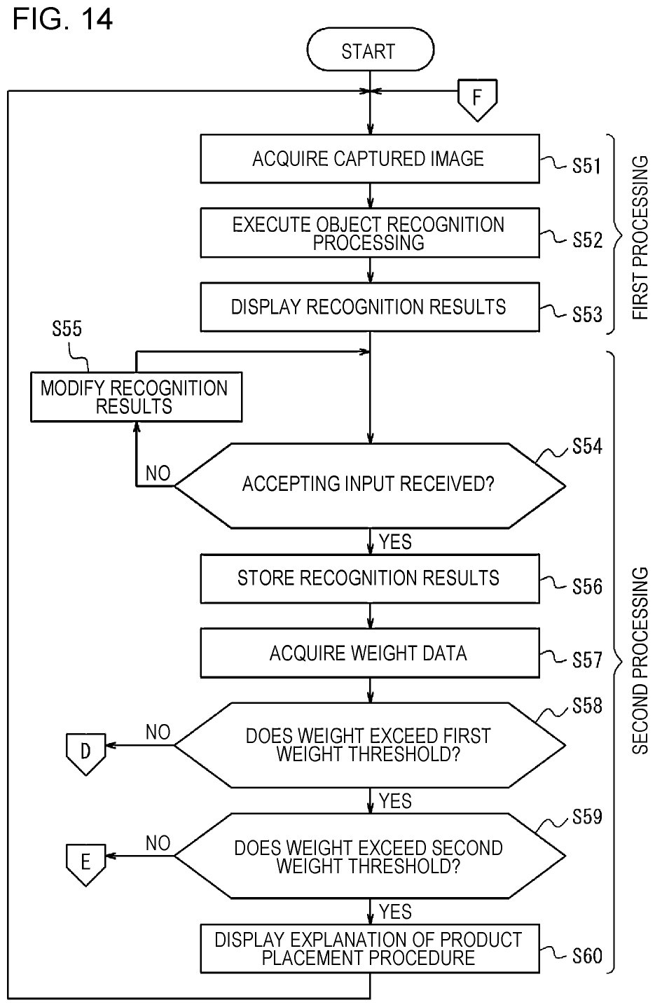

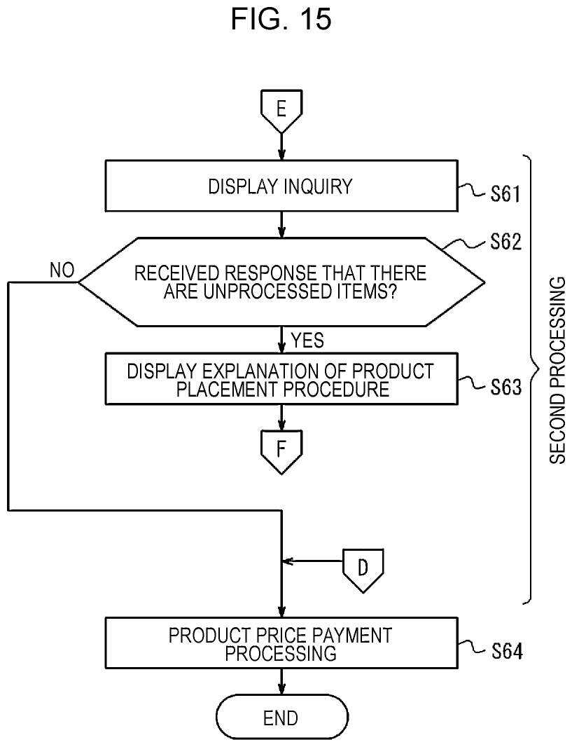

FIGS. 14 and 15 are flowcharts illustrating the procedures of an information processing method according to yet another embodiment of the present disclosure. This information processing method includes Steps S51 to S53 as the first processing, Steps S54 to S63 as the second processing, and Step S63 as the payment processing for the product price. For example, upon receiving an input instructing start of checkout from the input unit 22, the controller 24 starts the processing of Step S51.

The controller 24 performs the processing of Steps S51 to S56, which is the same as or similar to the processing of Steps S1 to S6 as illustrated in FIG. 8.

The controller 24 acquires data of the weight of the shopping basket from the weight sensor 81 by receiving the data via the communication unit 21 (Step S57).

The controller 24 determines whether or not the weight of the shopping basket acquired in the processing of Step S57 exceeds the first weight threshold (Step S58). When the weight of the shopping basket is determined to exceed the first weight threshold (Step S58: YES), the controller 24 proceeds to the processing of Step S59 When the weight of the shopping basket is determined to be less than or equal to the first weight threshold (Step S58: NO), the controller 24 proceeds to the processing of Step S64 as illustrated in FIG. 15.

In the processing of Step S59, the controller 24 determines whether or not the weight of the shopping basket acquired in the processing of Step S57 exceeds the second weight threshold. When the weight of the shopping basket is determined to exceed the second weight threshold (Step S59: YES), the controller 24 proceeds to the processing of Step S60. When the weight of the shopping basket is determined to be less than or equal to the second weight threshold (Step S59: NO), the controller 24 proceeds to the processing of Step S61 as illustrated in FIG. 15.

The controller 24 performs the processing of Step S60, which is the same as or similar to the processing of Step S9 as illustrated in FIG. 8. After performing the processing of Step S60, the controller 24 returns to the processing of Step S51.

The controller 24 performs the processing of Steps S61 to S64, as illustrated in FIG. 15, which is the same as or similar to the processing of Steps S7 to S10 as illustrated in FIG. 8.

When the processing of Steps S51 to S63 is repeated, the controller 24 does not need to perform the processing of Steps S60 and S63 for the second and subsequent times. If the processing of Step S60 is not performed for the second and subsequent times, when the controller 24 determines that the weight exceeds the second weight threshold (Step S59: YES), the controller 24 returns to the processing of Step S51. If the processing of Step S63 is not performed for the second and subsequent times, when the controller 24 determines that a response that there are unprocessed products has been received (Step S62: YES), the controller 24 returns to the processing of Step S51.

Other configurations and effects of the information processing device 20 according to the yet another embodiment are the same or similar to those of the information processing device 20 according to the embodiment described above.

The present disclosure has been described based on the drawings and examples, but note that a variety of variations and amendments may be easily made by one skilled in the art based on the present disclosure. Therefore, note that such variations and amendments are included within the scope of the present disclosure. For example, the functions and so forth included in each functional part can be rearranged in a logically consistent manner. Multiple functional parts and so forth may be combined into a single part or divided into multiple parts. Further, each embodiment according to the present disclosure described above does not need to be implemented exactly as described in the embodiment, and may be implemented with features having been combined or omitted as appropriate. A variety of variations and amendments to the content of the present disclosure can be made by one skilled in the art based on the present disclosure. Accordingly, such variations and amendments are included in the scope of the present disclosure. For example, in each embodiment, each functional part, each means, each step and so on can be added to other embodiments so long as there are no logical inconsistencies, or can be replaced with each functional part, each means, each step, and so on of other embodiments. In each embodiment, a plurality of each functional part, each means, each step, and so on can be combined into a single functional part, means, or step or divided into multiple functional parts, means, or steps. Each of the above-described embodiments of the present disclosure is not limited to faithful implementation of each of the described embodiments, and may be implemented by combining or omitting some of the features as appropriate.

For example, according to the above-described embodiments, in the information processing device 20, the controller 24 is described as outputting various information, such as recognition results, to the user by displaying the information as an image on the display device 13. However, the controller 24 may output various information such as recognition results to the user using any method other than an image. For example, the controller 24 may output various information, such as recognition results, to the user by causing a speaker to output the information as audio.

For example, in the above-described embodiments, the information processing method has been described as being performed by the information processing device 20. However, in the above-described embodiments, the device that executes the information processing method is not limited to the information processing device 20. In the above-described embodiments, any device may perform the information processing method. For example, in the above-described embodiments, the server 4 may perform the information.

For example, in the above-described embodiments, a general-purpose computer functioning as the information processing device 20 is also possible. Specifically, in the above-described embodiments, a program describing processing content that realizes each function of the information processing device 20 is stored in the memory of a general-purpose computer, and the program is read out and executed by a processor of the general-purpose computer. Therefore, the configurations according to the above-described embodiments can also be realized as a program executable by a processor or a non-transitory computer-readable medium storing this program.

In the present disclosure, “first”, “second,” and so on are identifiers used to distinguish between such configurations. Regarding the configurations, “first”, “second”, and so on used to distinguish between the configurations in the present disclosure may be exchanged with each other. For example, identifiers “first” and “second” may be exchanged between the first processing and the second processing. Exchanging of the identifiers take places simultaneously. Even after exchanging the identifiers, the configurations are distinguishable from each other. The identifiers may be deleted. The configurations that have had their identifiers deleted are distinguishable from each other by symbols. Just the use of identifiers such as “first” and “second” in the present disclosure is not to be used as a basis for interpreting the order of such configurations or the existence of identifiers with smaller numbers.

### REFERENCE SIGNS

1 payment system
2 network
3 information processing system
4 server
10 placement table
10s upper surface
11 support column
12 image-capturing unit
13 display device
14 image-capturing device
20 information processing device
21 communication unit
22 input unit
23 storage device
24 controller
30, 31, 32, 40, 50, 60 image
33, 34, 41, 42, 51, 61, 62 region
70 captured image
71, 72 object image
71a, 72a bounding rectangle
80 placement stand
80s upper surface
81 weight sensor

1. An information processing device comprising:
an input unit; and
a controller configured to:
perform first processing of outputting to a display device a recognition result of recognizing what product corresponds to an object in an image captured by an image-capturing device;
perform second processing of storing the recognition result in a storage device, and then output to the display device an inquiry as to whether or not there is an unprocessed product in response to receiving an input at the input unit, the input indicating that the recognition result is acceptable; and
perform the first processing again in response to receiving, at the input unit, a response to the inquiry as to whether or not there is an unprocessed product, the response indicating that there is an unprocessed product.

2. The information processing device according to claim 1, wherein
the controller is further configured to perform payment processing of paying a product price based on the recognition result stored in response to receiving, at the input unit, a response to the inquiry as to whether or not there is an unprocessed product, the response indicating that there is no unprocessed product.

3. The information processing device according to claim 1, wherein
the controller is further configured to
output an explanation of a product placement procedure to the user in response to receiving, at the input unit, a response to the inquiry as to whether or not there is an unprocessed product, the response indicating that there is an unprocessed product, and then
perform the first processing again.

4. The information processing device according to claim 1, wherein
the controller is further configured to perform the first processing after the controller outputs to the user an explanation of a procedure to place the products, when a response, to the inquiry as to whether or not there is an unprocessed product, that there is an unprocessed product is received at the input unit, when the controller estimates that the user is unfamiliar with operation.

5. The information processing device according to claim 1, wherein
the controller is further configured to perform the first processing without outputting to the user an explanation of a procedure to place the products, when the input unit receives a response, to the inquiry as to whether or not there is an unprocessed product, that there is an unprocessed product when the controller estimates that the user is not unfamiliar with operation.

6. The information processing device according to claim 4, wherein
the controller is configured to
measure a length of time from when the controller outputs the recognition result to the user until the input unit receives a user's input accepting or rejecting the recognition result, and
estimate that the user is unfamiliar with operation if the length of time is longer than a first time threshold.

7. The information processing device according to claim 4, wherein
the controller is configured to
measure a length of time from when the controller has detected a presence of a user in front of a placement table where the products are to be placed until when the user in front of the placement table has placed the products on the placement table, and
estimate that the user is unfamiliar with operation if the length of time is longer than a second time threshold.

8. The information processing device according to claim 1, wherein
the controller is configured to
estimate whether or not there is an unprocessed product in the second processing, and
when the controller estimates that there are no unprocessed products, perform a payment processing to pay the product price based on the recognition result stored without outputting to the user the inquiry as to whether or not there is an unprocessed product in the second processing.

9. The information processing device according to claim 8, wherein
the controller is further configured to
obtain a reliability of the estimation result as to whether or not there is an unprocessed product, and
perform a payment processing to pay a product price without outputting to the user the inquiry as to whether or not there is an unprocessed product in the second processing when the controller estimates that there is no unprocessed product and the reliability is greater than a reliability threshold.

10. The information processing device according to claim 8, wherein
the controller is configured to
obtain a reliability of the estimation result as to whether or not there is an unprocessed product, and
perform the first processing again without outputting to the user the inquiry as to whether or not there is an unprocessed product in the second processing when the controller estimates that there is an unprocessed product, and the reliability is greater than a reliability threshold.

11. The information processing device according to claim 8, wherein
the controller is further configured to
obtain a reliability of an estimation result as to whether or not there is an unprocessed product, and
output the inquiry as to whether or not there is an unprocessed product to the user in the second processing, regardless of the estimation result of whether or not there is an unprocessed product, when the reliability is equal to or less than a reliability threshold.

12. The information processing device according to claim 8, wherein
the controller is configured to estimate whether or not there is an unprocessed product in the second processing by:
analyzing data of a captured image generated by capturing an area around the placement table on which products are to be placed; and,
identifying whether or not a user in front of the placement table is holding a product.

13. The information processing device according to claim 8,
wherein the controller is configured to estimate that there is no unprocessed product when a weight of a shopping basket is less than or equal to a first weight threshold.

14. The information processing device according to claim 8,
wherein when a weight of a shopping basket exceeds a second weight threshold, the controller is configured to estimate that there is an unprocessed product and performs the first processing again without outputting the inquiry as to whether or not there is an unprocessed product to the user.

15. The information processing device according to claim 8,
wherein when a weight of a shopping basket exceeds a first weight threshold and is less than or equal to a second weight threshold, the controller is configured to output the inquiry as to whether or not there is an unprocessed product to the user.

16. An information processing device comprising:
an input unit configured to receive an input from a user; and
a controller configured to:
cause an output unit to output a recognition result of a product that is in an image captured by an imaging device; and
cause the output unit to output another recognition result indicating what product corresponds to an object in another image newly captured in response to receiving, at the input unit, an input indicating that there are one or more products to be recognized if another input received at the input device indicates that the recognition result is acceptable.

17. An information processing method comprising:
performing first processing, the first processing comprising:
obtaining data of a captured image;
recognizing what product corresponds to an object that is in the captured image; and
outputting a recognition result to a user;
performing second processing in response to receiving an input indicating that the recognition result is acceptable, the second processing comprising:
storing the recognition result in a memory; and
outputting, to the user, an inquiry as to whether or not there are one or more unprocessed products; and
performing the first processing again in response to receiving a response to the inquiry as to whether or not there are unprocessed objects, the response indicating that there are one or more unprocessed objects.
